(19) United States
(12) Patent Application Publication
(10) Pub. No.: US 2016/0208078 A1
(43) Pub. Date: Jul. 21, 2016

(54) NITROGEN CONTAINING POLYMER COMPOSITIONS HAVING REDUCED COMBUSTION TOXICITY

(71) Applicant: SABIC GLOBAL TECHNOLOGIES B.V., Bergen op Zoom (NL)

(72) Inventors: Ajit Bhaskar, Karnataka, Bangalore (IN); Theo Hoeks, Bergen op Zoom (NL); Jan Henk Kamps, Bergen op Zoom (NL); Wilson Cheung, Hillsborough, NJ (US); Xin Chen, West Chester, PA (US)

(21) Appl. No.: 15/023,531

(22) PCT Filed: Sep. 23, 2014
(86) PCT No.: PCT/US2014/056916

§ 371 Date: Mar. 21, 2016

Related U.S. Application Data
(60) Provisional application No. 61/881,185, filed on Sep. 23, 2013.

(51) Int. Cl. C08K 5/3492; C08K 3/34; C08K 5/56

(52) U.S. Cl. CPC C08K 5/34928; C08K 5/56; C08K 3/346

(57) ABSTRACT

The present disclosure relates to a nitrogen containing thermoplastic polymer composition having reduced combustion toxicity. The disclosed thermoplastic composition comprises at least one polyetherimide resin, and at least one combustion toxicant suppressant. Also disclosed is a method for making the disclosed thermoplastic polymer composition and an article of manufacture comprising the disclosed polymer composition.

### BACKGROUND

The formation of toxic gases like hydrogen cyanide (HCN) and carbon monoxide (CO) during combustion is a serious concern in certain markets including mass transportation. Carbon monoxide is produced from both smoldering and flaming combustion. The combustion of the nitrogen-containing materials can also result in the formation of highly lethal HCN gas. These toxic gases released in a fire and may lead to injury or death.

Accordingly, it would be beneficial to provide improved thermoplastic polymer compositions having low combustion toxicity without compromising other material mechanical, physical and flammability properties such as UL 94 V0 rating, impact properties and modulus. This and other needs are satisfied by the various aspects of the present disclosure.

### SUMMARY

In accordance with the purpose(s) of the invention, as embodied and broadly described herein, this disclosure, in one aspect, relates to thermoplastic polymer compositions comprising at least one nitrogen containing polymer resin in an amount in the range of from greater than 0 wt % to less than 100 wt % and at least one combustion toxicant suppressant in an amount in the range of from greater than 0 wt % to about 15 wt %, wherein the composition has a combustion toxicity lower than a combustion toxicity measured for a substantially identical reference composition in the absence of the combustion toxicant suppressant. The presence of the combustion toxicant suppressant has no or substantially no impact on the mechanical, physical and flammability properties such as UL 94 V0 rating, impact properties and modulus. In one aspect, the nitrogen containing polymer resin can comprise polyamides, polyimides, polyurethanes, or any combination or blend thereof. In yet another aspect, the nitrogen containing polymer resin can comprise a polyetherimide (PEI) resin.

Also disclosed are methods of forming said compositions; and articles of manufacture comprising the disclosed compositions.

According to aspects, the disclosed thermoplastic compositions comprise at least one combustion toxicant suppressant, wherein the suppressant comprises a metal oxide, a metalloporphyrin compound, a melamine compound or any combination thereof.

In still further aspects, also disclosed herein are articles of manufacture comprising the disclosed compositions.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

It is to be understood that both the foregoing general description and the following detailed description are exemplary and explanatory only and are not restrictive, as claimed.

### DETAILED DESCRIPTION OF ILLUSTRATIVE EMBODIMENTS

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

### Polyamides

In one aspect, the nitrogen containing polymer composition can comprise one or more polyamides. Polyamides are generally derived from the polymerization of organic lactams having from 4 to 12 carbon atoms. In one aspect, the lactam can have the formula (1)

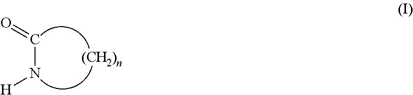

wherein n is about 3 to about 11. In one aspect, the lactam is epsilon-caprolactam having n equal to 5.

Polyamides can also be synthesized from amino acids having from 4 to 12 carbon atoms. In one aspect, the amino acids have the formula (2)

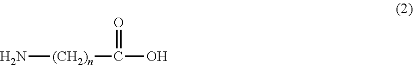

wherein n is about 3 to about 11. In one aspect, the amino acid is epsilon-aminocaproic acid with n equal to 5.

Polyamides can also be polymerized from aliphatic dicarboxylic acids having from 4 to 12 carbon atoms and aliphatic diamines having from 2 to 12 carbon atoms. In one aspect, the aliphatic diamines can have the formula (3)

H₂N—(CH₂)ₙ—NH₂ (3)

wherein n is about 2 to about 12. In one aspect, the aliphatic diamine is hexamethylenediamine (H₂N(CH₂)₆NH₂). The molar ratio of the dicarboxylic acid to the diamine can be about 0.66 to about 1.5. Within this range the molar ratio can be greater than or equal to about 0.81, or equal to about 0.96. In one aspect, this range is an amount of less than or equal to about 1.22, for example, less than or equal to about 1.04. In one aspect, the polyamides are nylon 6, nylon 6,6, nylon 4,6, nylon 6, 12, nylon 10, or the like, or combinations including at least one of the foregoing nylons.

### Polyetherimide (PEI)

As disclosed herein, the composition can comprise polyetherimides.

Polyetherimides includes polyetherimides copolymers. The polyetherimide can be selected from (i) polyetherimide homopolymers, e.g., polyetherimides, (ii) polyetherimide co-polymers, e.g., polyetherimidesulfones, and (iii) combinations thereof. Polyetherimides are known polymers and are sold by SABIC Innovative Plastics under the ULTEM®*, EXTEM®*, and Siltem* brands (Trademark of SABIC Innovative Plastics IP B.V.).

In an aspect, the polyetherimides can be of formula (4):

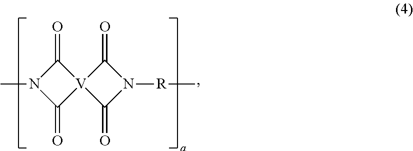

wherein a is more than 1, for example 10 to 1,000 or more, or more specifically 10 to 500. In one example, a can be 10-100, 10-75, 10-50 or 10-25.

The group V in formula (4) is a tetravalent linker containing an ether group (a “polyetherimide” as used herein) or a combination of an ether groups and arylenesulfone groups (a “polyetherimidesulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups; and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Suitable additional substitutions include, but are not limited to, ethers, amides, esters, and combinations comprising at least one of the foregoing.

The R group in formula (4) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (5):

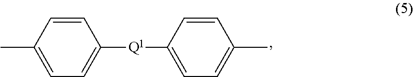

wherein Q1 includes but is not limited to a divalent moiety such as —O—, —S—, —C(O)—, —SO₂—, —SO—, —C_{y}H₂y- (y being an integer from 1 to 5), and halogenated derivatives thereof, including perfluoroalkylene groups.

In an aspect, linkers V include but are not limited to tetravalent aromatic groups of formula (6):

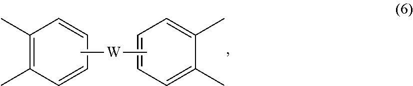

wherein W is a divalent moiety including —O—, —SO₂—, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (7):

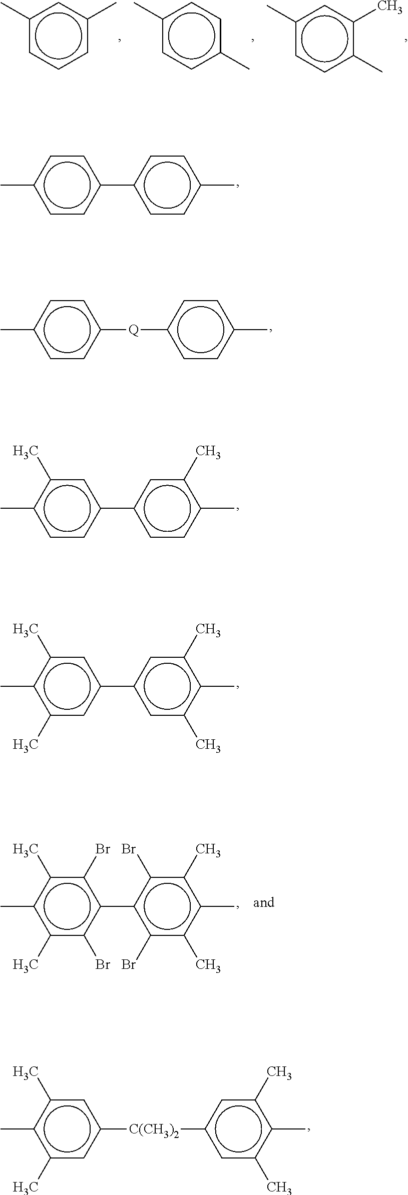

wherein Q includes, but is not limited to a divalent moiety including —O—, —S—, —C(O), —SO₂—, —SO—, —C_{y}H_{2y}— (y being an integer from 1 to 5), and halogenated derivatives thereof, including perfluoroalkylene groups.

The invention also utilizes the polyimides disclosed in U.S. Pat. No. 8,784,719 which is incorporated herein in its entirety. In addition, the polyetherimide resin can be selected from the group consisting of a polyetherimide, for example as described in U.S. Pat. Nos. 3,875,116; 6,919,422 and 6,355,723 a silicone polyetherimide, for example as described in U.S. Pat. Nos. 4,690,997; 4,808,686 a polyetherimidesulfone resin, as described in U.S. Pat. No. 7,041,773 and combinations thereof, each of these patents are incorporated herein their entirety.

In another aspect, the polyetherimide comprises 10 to 500 structural units of formula (8) and the polyetherimidesulfone contains 10 to 500 structural units of formula (9).

The polyetherimide and polyetherimidesulfone can be used alone or in combination with each other and/or other of the disclosed polymeric materials in fabricating the polymeric components of the invention. In one aspect, only the polyetherimide is used. In another aspect, the weight ratio of polyetherimide:polyetherimidesulfone can be from 99:1 to 50:50.

The polyetherimides can have a weight average molecular weight (Mw) of 5,000 to 100,000 grams per mole (g/mole) as measured by gel permeation chromatography (GPC). In some aspects the Mw can be 10,000 to 80,000. The molecular weights as used herein refer to the absolute weight averaged molecular weight (Mw).

The polyetherimides can have an intrinsic viscosity greater than or equal to 0.2 deciliters per gram (dl/g) as measured in m-cresol at 25° C. Within this range the intrinsic viscosity can be 0.35 to 1.0 dl/g, as measured in m-cresol at 25° C.

The polyetherimides can have a glass transition temperature of greater than 180° C., specifically of 200° C. to 500° C., as measured using differential scanning calorimetry (DSC) per ASTM test D3418. In some aspects, the polyetherimide and, in particular, a polyetherimide has a glass transition temperature of 200 to 350° C.

The polyetherimides can have a melt index of 0.1 to 10 grams per minute (g/min), as measured by American Society for Testing Materials (ASTM) DI 238 at 340 to 370° C., using a 6.7 kilogra

In a further aspect, the polyetherimide has a structure represented by a formula (8):

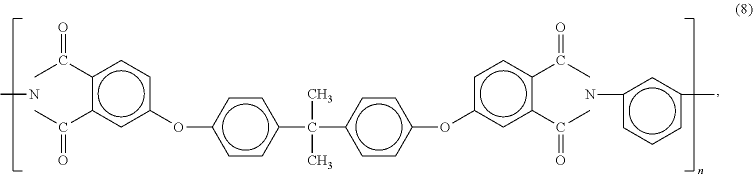

wherein the polyetherimide polymer has a molecular weight of at least 20,000, 30,000, 40,000 Daltons, 50,000 Daltons, 60,000 Daltons, 80,000 Daltons, or 100,000 Daltons. In one aspect, the polyetherimide comprises

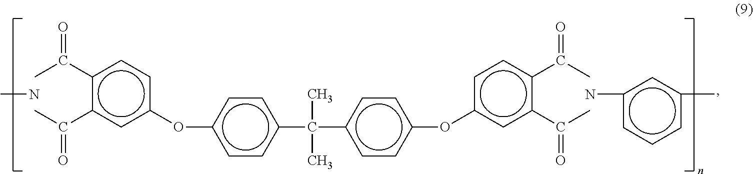

wherein n is an integer greater than 1, for example greater than 10. In one aspect n is between 2-100, 2-75, 2-50 or 2-25, for example 10-100, 10-75, 10-50 or 10-25. In another example, n can be 38, 56 or 65.

### B. Metal Oxides

As disclosed herein, the thermoplastic polymer composition can comprise metal oxides. The metal oxides can comprise transition metals, alkaline earth metals, and metallic elements of Groups 3A, 4A, and 5A of the periodic table of elements, or any combination thereof. Transition metals can comprise Sc, Ti, V, Cr, Mn, Fe, Co, Ni, Cu, Zn, Y, Zr, Nb, Mo, Tc, Ru, Th, Pd, Ag, Cd, Ba, La, Hf, Ta, W, Re, Os, Ir, Pt, Au, Hg, Ac, or any combination thereof. Alkaline earth metals comprise Be, Mg, Ca, Sr, Ba, or any combination thereof. Group 4A metallic elements comprise B, Al, Ga, In, Tl, or any combination thereof. Group 5A metallic elements can comprise As, Sb, Bi, or any combination thereof.

In one aspect, the thermoplastic polymer composition comprises at least one oxide of copper, or tungsten, or any combination thereof. In yet another aspect, the thermoplastic composition comprises a copper (II) oxide. In a further aspect, the thermoplastic composition comprises copper (I) oxide and/or tungsten oxide. In one aspect, the copper oxide and/or tungsten oxide is present in an amount in the range of from greater than 0 wt % to about 15 wt %, including exemplary amounts of 0.01 wt %, 0.05 wt %, 0.07 wt %, 0.09 wt %, 0.1 wt %, 0.2 wt %, 0.5 wt %, 1 wt %, 1.5 wt %, 2 wt %, 4 wt %, 6 wt %, 8 wt %, 10 wt %, 12 wt %, and 14 wt %, based on the total weight of the composition. In a further aspect, the copper oxide and/or tungsten oxide can be present in any range derived from any two values set forth above.

In one aspect, the thermoplastic composition comprises a combination of copper and tungsten oxides, wherein the copper oxide can be present as the copper (I) oxide, copper (II) oxide, or a combination thereof. The proportions of each oxide components in the mixture can vary within the total amount. In one aspect the proportion of the copper oxide is at least 0.1, and the proportion of the tungsten oxide is at least 0.1. In one aspect, the oxide components can be present in any ratio based on 100 parts of the mixture.

In one aspect, the metal oxides can be added as microparticles. In another aspect, the metal oxides can be added as nanoparticles. In yet another aspect, the metal oxide can be added as sols, solutions, powders, or a combination thereof. In one aspect, the metal oxide is uniformly dispersed in the thermoplastic polymer composition

### C. Metalloporphyrins

The disclosed thermoplastic polymer composition can further comprise a metalloporphyrin compound. In one aspect, the metalloporphyrin compounds can comprise any porphyrin compound with a metal center selected from Co, Fe, Cu, Ni, Ag, and Mg.

In one aspect, the metalloporphyrin compound is present in an amount in the range of from greater than 0 wt % to about 15 wt %, including exemplary amounts of 0.01 wt %, 0.05 wt %, 0.07 wt %, 0.09 wt %, 0.1 wt %, 0.2 wt %, 0.5 wt %, 1 wt %, 1.5 wt %, 2 wt %, 3 wt %, 4 wt %, 5 wt %, 6 wt %, 7 wt %, 8 wt %, 9 wt %, 10 wt %, 11 wt %, 12 wt %, 13 wt %, and 14 wt % based on the total weight of the composition. In a further aspect, the metalloporphyrin compound can be present in any range derived from any two values set forth above. For example, the metalloporphyrin compound can be present in an amount in the range of from about 0.01 wt % to about 5 wt %.

### D. Melamine Compounds

The disclosed thermoplastic polymer composition can further comprise a melamine compound or a mixture of melamine compounds. The melamine compound which is used as a combustion toxicant suppressant in the disclosed composition can comprise well known compounds which are generally commercially available or can be readily prepared by known and conventional methods.

Melamine compounds can be represented by the general formula (16)

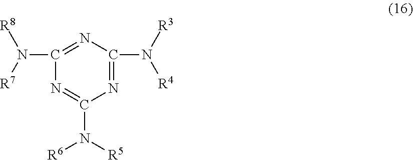

wherein R³-R⁸ are independently selected from hydrogen, monovalent hydrocarbon radicals, substituted monovalent radicals, —CH₂OH, and —CH₂O(CH₂)ₓH, wherein x is an integer from 1 to about 4; with the proviso that when R³-R⁸ are selected from monovalent hydrocarbon radicals, and substituted monovalent hydrocarbon radicals the total number or sum of the carbon atoms present in R³-R⁸ does not exceed about 20, does not exceed 10, or does not exceed 6.

In one aspect, the melamine compound can be present in amount of from greater than 0 wt % to about 60 wt %, including exemplary amounts of greater than 3 wt %, greater than 5 wt %, greater than 10 wt %, greater than 20 wt %, greater than 30 wt %, or greater than 40 wt %. In another aspect, the melamine compound can be present in amount less than 60 wt % based on the total weigh of the composition. In yet another aspect the melamine compound can be present in an amount of less than 50 wt %, less than 40 wt %, less than 30 wt %, less than 20 wt %, less than 10 wt %, less than 8 wt %, less than 5 wt %, or less than 1 wt %. In a further aspect, the melamine compound can be present in any range derived from any two values set forth above. For example, the melamine compound can be present in an amount in the range of from about 0.5 to 15 wt %.

### Aspects

Aspect 1. A thermoplastic polymer composition comprising (a) at least one nitrogen containing polymer resin in an amount in the range of from greater than 0 wt % to less than 100 wt %; (b) at least one combustion toxicant suppressant in an amount in the range of from greater than 0 wt % to about 15 wt %, wherein the composition has a combustion toxicity lower than a combustion toxicity measured for a substantially identical reference composition in the absence of the combustion toxicant suppressant, and wherein the presence of the combustion toxicant suppressant has no or substantially no impact on the mechanical, physical and flammability properties such as UL 94 V0 rating, impact properties and modulus.

Aspect 2. The composition of Aspect 1, wherein the nitrogen containing polymer resin comprises polyamides, polyimides, polyurethanes, or any combination or blend thereof.

Aspect 3. The composition of Aspect 1 or 2, wherein the nitrogen containing resin comprises a polyetherimide (PEI) resin.

Aspect 4. The composition of Aspect 4, wherein the polyetherimide resin comprises a polyetherimide homopolymer, a copolymer, or any combination or blend thereof.

5. The composition of claim 4 or 5, wherein the polyetherimide has a structure of:

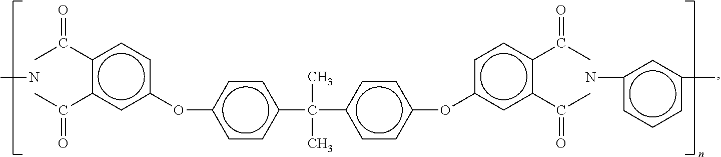

wherein n is an integer greater than 1, and wherein the polyetherimide has a molecular weight of at least 20,000 Daltons.

Aspect 6. The composition of anyone of Aspects 1-5, wherein the combustion toxicant suppressant comprises a metal oxide, a metalloporphyrin compound, a melamine compound or a combination thereof.

Aspect 7. The composition of Aspect 6, wherein the metal oxide comprises an oxide of transition metals, alkaline earth metals, metallic elements of Groups 3A, 4A, and 5A of the periodic table of elements, or any combination thereof.

Aspect 8. The composition of Aspect 6 or 7, wherein the metal oxide comprises an oxide of copper, tungsten, zinc oxide, or any combination thereof.

Aspect 9. The composition of Aspect 6 or 7, wherein the melamine compound is represented by formula:

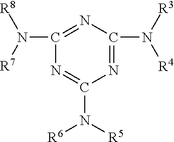

wherein R³-R⁸ are independently selected from hydrogen, monovalent hydrocarbon radicals, substituted monovalent hydrocarbon radicals, —CH₂OH, or —CH₂O(CH₂)ₓH, wherein x is an integer of from 1 to about 4, with the proviso that when R³-R⁸ are selected from monovalent hydrocarbon radicals or substituted monovalent hydrocarbon radicals, the total number of carbon atoms present in R³-R⁸ does not exceed 20.

Aspect 10. The composition of any one of Aspects 1-9, wherein the composition passes the BS6853:1999 test of the British Rail-standard when tested at a temperature about 600° C.

Aspect 11. The composition of any one of Aspects 1-10, wherein a toxicity index value (ITC) is less than 15 when measured at temperatures in the range of from 500° C. to 900° C.

Aspect 12. The composition of any one of Aspects 1-11, further comprising an inorganic filler, wherein the inorganic filler comprises a kaolin, carbon fiber, carbon black, glass fiber, aramid fiber, or a combination thereof.

Aspect 13. The composition of any one of Aspects 1-12, wherein the composition can further comprise at least one flame retardant.

Aspect 14. An article formed from the composition of any of Aspects 1-13.

Aspect 15. The article of Aspect 14 comprising textiles, mattresses, seats, exterior and interior materials used in a transportation industry.

Aspect 16. A method of forming a thermoplastic polymer composition comprising combining: (i) at least one nitrogen containing polymer resin in an amount in the range of from greater than 0 wt % to less than 100 wt % and (ii) at least one combustion toxicant suppressant in an amount in the range of from greater than 0 wt % to about 15 wt %, wherein the composition has a combustion toxicity lower than a combustion toxicity measured for a substantially identical reference composition in the absence of the combustion toxicant suppressant, and wherein the presence of the combustion toxicant suppressant has no or substantially no impact on the mechanical, physical and flammability properties such as UL 94 V0 rating, impact properties and modulus.

Aspect 17. The method of Aspect 16, wherein the nitrogen containing polymer resin comprises polyamides, polyimides, polyurethanes, or any combination or blend thereof.

Aspect 18. The method of Aspect 16 or 17, wherein the nitrogen containing resin comprises a polyetherimide (PEI) resin.

Aspect 19. The method of Aspect 18 wherein the polyetherimide has a structure:

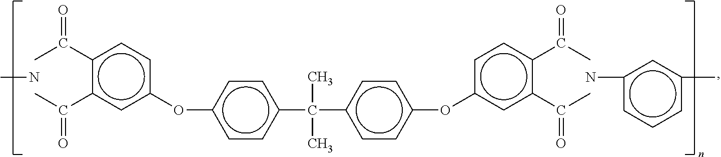

wherein n is an integer greater than 1, and wherein the polyetherimide has a molecular weight of at least 20,000 Daltons.

Aspect 20. The method of any one of Aspects 16-19, wherein the combustion toxicant suppressant comprises a metal oxide, a metalloporphyrin compound, a melamine compound or a combination thereof.

### DEFINITIONS

As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed. “About” is intended to include the degree of error associated with measurement of the particular quantity based upon the equipment available at the time of filing the application.

Disclosed are component materials to be used to prepare disclosed compositions of the invention as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein.

References in the specification and concluding claims to parts by weight, of a particular element or component in a composition or article denotes the weight relationship between the element or component and any other elements or components in the composition or article for which a part by weight is expressed.

A weight percent of a component, unless specifically stated to the contrary, is based on the total weight of the formulation or composition in which the component is included.

Compounds disclosed herein are described using standard nomenclature. Unless defined otherwise, technical and scientific terms used herein have the same meaning as is commonly understood by one of skill in the art to which this invention belongs.

As used herein, the terms “polydispersity index” or “PDI” can be used interchangeably, and are defined by the formula:

$$PDI = \frac{Mw}{Mn} .$$

The PDI has a value equal to or greater than 1, but as the polymer chains approach uniform chain length, the PDI approaches unity.

As used herein, the terms “weight average molecular weight” or “Mw” can be used interchangeably, and are defined by the formula:

$$Mw = \frac{\sum {N}_{t} {M}_{t}^{2}}{\sum {N}_{t} {M}_{t}} ,$$

where Mᵢ is the molecular weight of a chain and Nᵢ is the number of chains of that molecular weight. Mw can be determined for the disclosed polymers by methods well known to a person having ordinary skill in the art. Unless specified to the contrary, the term molecular weight refers to M_{w}.

The index “n” as used herein in connection with polymer structures, refers to a number of repeating units in a polymer composition. According to aspects, the value of “n” can be any integer greater than 1.

The terms “polyamide” or “polyamides” as used herein refer to any one of a class of synthetic polymeric materials containing a recurring —CONH— group.

The term “polyimides” refers to a polymer of imide monomers.

The terms “polyetherimide” or “PEI” are used interchangeably and refer to a combination polymer that has both polyimide and polyether units in the backbone. A commercially available example of PEI is the ULTEM line of materials sold by Saudi Basic Industries Corporation (SABIC) Innovative Plastics.

The term “combustion toxicant suppressant” as used herein refers to a chemical or additive which, when added to a combustible material, reduces or substantially reduces, prevents or substantially prevents one or more toxic gases from being generated when the combustible material undergoes thermal decomposition. In another aspect, the “combustion toxicant suppressant” refers to a chemical capable catalyzing a further degradation of a toxic gas to resulting products of a lower toxicity. In yet another aspect, toxic gases comprise hydrogen cyanide (HCN). In a further aspect, toxic gases comprise carbon monoxide (CO). In a yet further aspect, toxic gases comprises a mixture of hydrogen cyanide and carbon monoxide.

The term “substantially identical reference composition” can refer to a composition having the same amount of the same combination of components enumerated for a base composition (less any directly excluded components) to which the reference composition is compared. The conditions of forming such a reference composition can be the same or substantially the same as the base composition.

The term “substantially no impact” can refer to a change within a standard deviation of the subject property measured on the reference composition and/or maintaining a rating such a UL94 V0 rating, for example.

The terms “weight summation of toxic fumes” or “R” are used interchangeably and refer to a numerical value that is used to compare the toxicity of various gases and are defined by the formula:

$${r}_{x} = \frac{{c}_{x}}{{f}_{x}} ; R = \sum r ;$$

wherein cₓ defines an emission of the x^{th} species, in appropriate units; fₓ describes a reference value for x^{th} species; rₓ describes the individual index for the x^{th} species; and R describes the weight summation of toxic fumes. In one aspect, the rₓ values can be established pursuant to the BS6853:1999 standard.

The terms “toxicity index” or “ITC” are used interchangeably and refer to a numerical value that used to compare the toxicity of various gases and are defined by the formula:

$$ITC = \frac{100}{m} \times \sum \frac{{M}_{z}}{{CC}_{z}} ;$$

wherein m defines a weight of the sample, in [g] units; M_{z} defines a weight of gas z produced by the sample combustion, in [mg] units; CC_{z} defines a critical concentration for 30 minutes exposure for gas z, in [mg/m³] units. In one aspect, the ITC can be calculated according to the EN50305:2002 standard.

Unless otherwise stated to the contrary herein, all test standards are the most recent standard in effect at the time of filing this application.

Each of the materials disclosed herein are either commercially available and/or the methods for the production thereof are known to those of skill in the art.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Unless indicated otherwise, percentages referring to composition are in terms of wt %.

### General Materials and Methods

Heat deflection temperature was determined per ISO 75 and ASTM D648 standard at 1.82 MPa and is provided in units of ° C.

The notched Izod impact (“NII”) test was carried out on 80 mm×10 mm×4 mm molded samples (bars) according to ISO180 at 23° C. Test samples were conditioned in ASTM standard conditions of 23° C. and 55% relative humidity for 48 hours and then were evaluated. NII was determined using a Ceast Impact Tester. NII is reported in kg-cm/cm units. Flexural properties (modulus and strength) were measured using 3.2 mm bars in accordance with ISO 178. Flexural strength (in units of kg/cm²) and flexural modulus (in units of kg/cm²) are reported at yield.

Tensile properties (strength and elongation) were measured on 3.2 mm bars in accordance with ISO 527 using sample bars prepared in accordance with ISO 3167 Type 1A multipurpose specimen standards. Tensile strength is reported in units of kg/cm² and tensile elongation is reported in %.

Melt volume-flow rate (“MFR”) was determined according to standard ISO 1133 under the following test conditions: 260° C./2.16 kgf load in accordance with ASTM D1238.

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1, or UL94 V2 on the basis of the test results obtained for five samples. The procedure and criteria for each of these flammability classifications according to UL94 are, briefly, as follows. Multiple specimens (either 5 or 10) are tested per thickness. Some specimens are tested after conditioning for 48 hours at 23° C., 50% relative humidity. The other specimens are tested after conditioning for 168 hours at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded (T1). If burning ceases, the flame is re-applied for an additional 10 seconds. Again, the time until the flaming of the bar ceases is recorded (T2). If the specimen drips particles, these shall be allowed to fall onto a layer of untreated surgical cotton placed 305 mm below the specimen.

V0: In a sample placed so that its long axis is 180 degrees to the flame, the maximum period of flaming and/or smoldering after removing the igniting flame does not exceed 10 seconds and none of the vertically placed samples produces drips of burning particles that ignite absorbent cotton, and no specimen burns up to the holding clamp after flame or after glow.

V1: In a sample places so that its long axis is 180 degree to the flame, the average period of flaming and/or smoldering after removing the igniting flame does not exceed 30 seconds and none of the vertically placed samples produces drips of burning particles that ignite absorbent cotton. Five bar flame out time (FOT) is the sum of the flame out time for five bars, each lit twice for a maximum flame out time of 250 seconds.

The data were also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) can be determined according to the formula:

p(FTP)−(P_{t1>mbt,n=0}×P_{t2>mbt,n=0}×P_{total<=mtbt}×P_{drip,n=0})

where P_{t1>mbt,n=0} is the probability that no first burn time exceeds a maximum burn time value, P_{t2>mbt,n=0} is the probability that no second burn time exceeds a maximum burn time value, P_{total<=mtbt} is the probability that the sum of the burn times is less than or equal to a maximum total burn time value, and P_{drip,n=0} is the probability that no specimen exhibits dripping during the flame test. First and second burn time refer to burn times after a first and second application of the flame, respectively.

The probability that no first burn time exceeds a maximum burn time value, P_{t1>mbt,n=0}, may be determined the formula:

P_{t1>mbt,n=0}=(1−P_{t1>mbt})⁵

where P_{t1>mbt} is the area under the log normal distribution curve for t1>mbt, and where the exponent “5” relates to the number of bars tested. The probability that no second burn time exceeds a maximum burn time value can be determined from the formula:

P_{t2>mbt,n=0}=(1−P_{t2>mbt})

where P_{t2>mbt} is the area under the normal distribution curve for t2>mbt. As above, the mean and standard deviation of the burn time data set are used to calculate the normal distribution curve. For the UL-94 V0 rating, the maximum burn time is 10 seconds. For a V1 or V2 rating the maximum burn time is 30 seconds. The probability P_{drip,n=0} that no specimen exhibits dripping during the flame test is an attribute function, estimated by:

P_{drip,n=0}=(1−P_{drip})⁵

where P_{drip}=(the number of bars that drip/the number of bars tested).

The probability P_{total<=mtbt} that the sum of the burn times is less than or equal to a maximum total burn time value can be determined from a normal distribution curve of simulated 5-bar total burn times. The distribution can be generated from a Monte Carlo simulation of 1000 sets of five bars using the distribution for the burn time data determined above. Techniques for Monte Carlo simulation are well known in the art. A normal distribution curve for 5-bar total burn times can be generated using the mean and standard deviation of the simulated 1000 sets. Therefore, P_{total<=mtbt} can be determined from the area under a log normal distribution curve of a set of 1000 Monte Carlo simulated 5-bar total burn time for total≦maximum total burn time. For the UL-94 V0 rating, the maximum total burn time is 50 seconds. For a V1 or V2 rating, the maximum total burn time is 250 seconds.

Methods of testing, collection of gases, analysis and quantification for toxicity determination has been carried out according to the established standards EN 50305, NFX 70-100, and BS6853:1999.

### Methods of Sample Preparation

The samples have been extruded in a co-rotating twin screw extruder. The extruder consists of six heating zones. The premixed polymer and the toxicant suppressant have been added through the feeder at the rate of 10 kg per hour. The temperatures in the heating zone have been kept at 180, 290, 300, 310, 320, and 330° C. respectively. The pellets have been prepared from the extruded polymer and dried at 120° C. for 8 hours and then injection molded into various parts. The exemplary parts include but are not limited to tensile bars, impact bars, flame resistance, and testing bars.

### Example 1

Table 1 describes the additives used in the studies utilizing metalloporphyrin and melamine as toxicant suppressants.

TABLE 1
Additives used in the metalloporphyrin and
melamine containing compounds studies.

| Additive | Supplier | Item | Particle size | | Wt % |
|---|---|---|---|---|---|
| Aluminum | KAMIN | KaMin HG90 | 0.2-0.4 | μm | 0.4 |
| Silicate | | (water- | | | |
| | | washed clay) | | | |
| Kaolin (CAS | | | | | 2.0 |
| 1332-58-7) | | | | | 4.0 |
| | | | | | 10 |
| Kaolin | | Polyfil | 380 | nm | 0.4 |
| Clay | | NG - ~380 | | | 2.0 |
| | | nm water | | | 4.0 |
| | | washed | | | 10 |
| | | kaolin clay | | | |
| Calcined | | | 1.4 | μm | 0.4 |
| Clay | | | | | 2.0 |
| | | | | | 4.0 |
| | | | | | 10 |
| Calcined | | Nylok-171- | 1.4 | μm | 0.4 |
| Clay | | calcined clay, | | | 2.0 |
| | | amino | | | 4.0 |
| | | functional | | | 10 |
| | | surface | | | |
| | | treatment | | | |

| | | | |
|---|---|---|---|
| 5,10,15,20- | Sigma- | 275867 | 1.0 |
| Tetrakis(4- | Aldrich | | 3.0 |
| methoxyphenyl)- | | | 5.0 |
| 21H,23H-porphine | | | |
| cobalt(II) | | | |
| (CoTPP) | | | |
| CAS 28903-71-1 | | | |
| Melamine | Budenheim | Build 3141 | 1.2 |
| polyphosphate | | | 2.5 |
| (MPolyP) | | | 6.2 |
| CAS 218768-84-4 | | | |

### Example 2

Toxicity tests have been performed by the third party Test Lab—Currenta, according to the BS6853:1999 and EN50305 standards at the chosen temperatures of 600° C. and/or 800° C. The ITC data shown in Table 2 has been measured for various polymer compositions marked as Examples 1-31 and described herein at the temperatures of 600° C. and 800° C. Rₘₐₓ and rₓ data for Examples 1-31, measured at the same temperatures, are shown in Table 3. Table 4 summarizes BS6853:1999 standard values (Rₘₐₓ) used for the toxicity tests for the various stated applications, wherein categories Iₐ, I_{b}, and II refer to the specific testing conditions determined by the BS6853:1999 standard.

TABLE 2
Toxicity data (ITC) measured for EXAMPLES 1-31.

| | | | | | ITC | ITC | ITC | ITC | ITC | ITC | |
|---|---|---|---|---|---|---|---|---|---|---|---|
| EX | UL | Cu₂O | WO₃ | ZnO | CO | CO₂ | SO₂ | HCN | NOₓ | HF | ITC |
| 1 | 1010 | | | | 14.9 | 1.6 | 0.0 | 20.6 | 0.7 | | 37.8 |
| (600° C.) | (natural) | | | | | | | | | | |
| 2 | 1010 | | | 4 | 12.0 | 1.7 | 0.0 | 7.1 | 1.5 | | 22.3 |
| (600° C.) | | | | nanosize | | | | | | | |
| 3 | 1010 | 4 | | | 6.5 | 2.2 | 0.0 | 1.3 | 2.4 | | 12.4 |
| (600° C.) | | | | | | | | | | | |
| 4 | 1010 | | 5 | | 31.4 | 1.2 | 0.0 | 22.6 | 2.3 | | 57.4 |
| (600° C.) | | | | | | | | | | | |
| 5 | 1010 | | | | 39.9 | 1.0 | 0.0 | 22.6 | 1.2 | 0 | 64.8 |
| (600° C.) | (natural) | | | | | | | | | | |
| 6 | 1010 | | 7.5 | | 15.9 | 1.7 | 0.0 | 30.2 | 1.7 | 0 | 49.5 |
| (600° C.) | | | nanosize | | | | | | | | |
| 7 | 1010 | | 10 | | 34.6 | 1.2 | 0.0 | 22.5 | 2.1 | 0 | 60.3 |
| (600° C.) | | | nanosize | | | | | | | | |
| 8 | 1010 | 5 | 5 | | 10.4 | 2.0 | 0.0 | 3.4 | 2.1 | 0 | 17.9 |
| (600° C.) | | | nanosize | | | | | | | | |
| 9 | 1011 | | 5 | | 22.3 | 1.6 | 0.0 | 24.4 | 3.0 | 0 | 51.2 |
| (600° C.) | | | <20 μm | | | | | | | | |
| 10 | 1011 | | 7.5 | | 39.4 | 1.0 | 0.0 | 8.5 | 2.2 | 0 | 51.1 |
| (600° C.) | | | <20 μm | | | | | | | | |
| 11 | 1011 | | 10 | | 331.9 | 1.3 | 0.0 | 19.8 | 2.4 | 0 | 55.3 |
| (600° C.) | | | <20 μm | | | | | | | | |
| 12 | 1010 | | | | 5.2 | 2.1 | 0.0 | 6.6 | | 0.3 | 14.3 |
| (800° C.) | natural | | | | | | | | | | |
| 13 | 1010 | | | | 5.2 | 2.3 | 0.0 | 4.1 | | 0.8 | 12.6 |
| (800° C.) | yellow | | | | | | | | | | |
| 14 | 1010 | | | | 3.6 | 1.3 | 0.0 | 4.6 | | 0.5 | 10.1 |
| (800° C.) | grey | | | | | | | | | | |
| 15 | 1010 | 2 | | | 4.5 | 2.3 | 0.0 | 5.9 | | 0.3 | 13.1 |
| (800° C.) | | | | | | | | | | | |
| 16 | 1010 | 4 | | | 4.4 | 2.4 | 0.0 | 5.0 | | 0.3 | 12.1 |
| (800° C.) | | | | | | | | | | | |
| 17 | 1010 | | 5 | | 3.4 | 2.4 | 0.0 | 3.0 | | 0.3 | 9.2 |
| (800° C.) | | | | | | | | | | | |
| 18 | 1010 | | | | 5.6 | 2.1 | 0.0 | 6.5 | 0.2 | 0 | 14.4 |
| (800° C.) | natural | | | | | | | | | | |
| 19 | 1010 | | | 4 | 4.8 | 2.1 | 0.0 | 7.4 | 0.3 | 0 | 14.5 |
| (800° C.) | | | | nanosize | | | | | | | |
| 20 | 1010 | | | | 4.8 | 2.0 | 0.0 | 6.2 | 0.2 | 0 | 13.2 |
| (800° C.) | 10 wt % | | | | | | | | | | |
| | nanosilica | | | | | | | | | | |
| | (Gabot) | | | | | | | | | | |
| 21 | 1010 | | | 4 | 5.2 | 2.0 | 0.0 | 7.8 | 0.2 | 0 | 15.2 |
| (800° C.) | | | | Merck | | | | | | | |
| 22 | 1010 | | | 4 | 5.1 | 2.1 | 0.0 | 6.9 | 0.2 | 0 | 14.3 |
| (800° C.) | | | | <5 mm | | | | | | | |
| 23 | 1010 | 4 | | | 4.8 | 1.6 | 0.0 | 5.9 | 0.0 | 0 | 12.4 |
| (800° C.) | | | | | | | | | | | |
| 24 | 1010 | | 5 | | 5.1 | 2.1 | 0.0 | 4.9 | 0.0 | 0 | 12.1 |
| (800° C.) | | | | | | | | | | | |
| 25 | 1010 | | | | 5.4 | 2.2 | 0.0 | 6.0 | 0.3 | 0 | 13.9 |
| (800° C.) | (natural) | | | | | | | | | | |
| 26 | 1010 | | | 7.5 | 3.3 | 2.3 | 0.0 | 5.2 | 0.0 | 0 | 10.8 |
| (800° C.) | | | | nanosize | | | | | | | |
| 27 | 1010 | | | 10 | 3.4 | 2.3 | 0.0 | 6.4 | 0.0 | 0 | 12.1 |
| (800° C.) | | | | nanosize | | | | | | | |
| 28 | 1010 | 5 | | 5 | 3.0 | 2.1 | 0.0 | 5.2 | 0.0 | 0 | 10.2 |
| (800° C.) | | | | nanosize | | | | | | | |
| 29 | 1010 | | 5 | | 3.8 | 2.0 | 0.0 | 5.8 | 0.0 | 0 | 11.5 |
| (800° C.) | | | <20 μm | | | | | | | | |
| 30 | 1010 | | 7.5 | | 4.3 | 2.2 | 0.0 | 6.5 | 0.0 | 0 | 13.1 |
| (800° C.) | | | <20 μm | | | | | | | | |
| 31 | 1010 | | 10 | | 3.9 | 1.9 | 0.0 | 6.7 | 0.3 | 0 | 12.8 |
| (800° C.) | | | <20 μm | | | | | | | | |

TABLE 3
Toxicity Data: Rₘₐₓ and rₓ values measured for EXAMPLES 1-31.

| | | | | | r | r | r | r | r | |
|---|---|---|---|---|---|---|---|---|---|---|
| EX | UL | Cu₂O | WO₃ | ZnO | CO | CO₂ | SO₂ | HCN | NOₓ | R |
| 1 (600° C.) | 1010 | | | | 0.9 | 0.1 | 0.0 | 1.0 | 0.1 | 2.15 |
| | (natural) | | | | | | | | | |
| 2 (600° C.) | 1010 | | | 4 | 0.8 | 0.1 | 0.0 | 0.4 | 0.2 | 1.39 |
| | | | | nanosize | | | | | | |
| 3 (600° C.) | 1010 | 4 | | | 0.4 | 0.1 | 0.0 | 0.1 | 0.3 | 0.89 |
| 4 (600° C.) | 1010 | | 5 | | 2.0 | 0.1 | 0.0 | 1.1 | 0.3 | 3.43 |
| 5 (600° C.) | 1010 | | | | 2.5 | 0.1 | 0.0 | 1.1 | 0.1 | 3.84 |
| | (natural) | | | | | | | | | |
| 6 (600° C.) | 1010 | | 7.5 | | 1.0 | 0.1 | 0.0 | 1.5 | 0.2 | 2.82 |
| | | | nanosize | | | | | | | |
| 7 (600° C.) | 1010 | | 10 | | 2.2 | 0.1 | 0.0 | 1.1 | 0.3 | 3.61 |
| | | | nanosize | | | | | | | |
| 8 (600° C.) | 1010 | 5 | 5 | | 0.6 | 0.1 | 0.0 | 0.2 | 0.3 | 1.20 |
| | | | nanosize | | | | | | | |
| 9 (600° C.) | 1011 | | 5 | | 1.4 | 0.1 | 0.0 | 1.2 | 0.4 | 3.06 |
| | | | <20 um | | | | | | | |
| 10 (600° C.) | 1011 | | 7.5 | | 2.5 | 0.1 | 0.0 | 0.4 | 0.3 | 3.21 |
| | | | <20 um | | | | | | | |
| 11 (600° C.) | 1011 | | 10 | | 2.0 | 0.1 | 0.0 | 1.0 | 0.3 | 3.34 |
| | | | <20 um | | | | | | | |
| 12 (800° C.) | 1010 | | | | 0.3 | 0.1 | 0.0 | 0.3 | | 0.79 |
| | (natural) | | | | | | | | | |
| 13 (800° C.) | 1010 | | | | 0.3 | 0.1 | 0.0 | 0.2 | | 0.69 |
| | yeallow | | | | | | | | | |
| 14 (800° C.) | 1010 | | | | 0.2 | 0.1 | 0.0 | 0.2 | | 0.54 |
| | grey | | | | | | | | | |
| 15 (800° C.) | 1010 | 2 | | | 0.3 | 0.1 | 0.0 | 0.3 | | 0.73 |
| 16 (800° C.) | 1010 | 4 | | | 0.3 | 0.2 | 0.0 | 0.2 | | 0.68 |
| 17 (800° C.) | 1010 | | 5 | | 0.2 | 0.2 | 0.0 | 0.2 | | 0.52 |
| 18 (800° C.) | 1010 | | | | 0.3 | 0.1 | 0.0 | 0.3 | 0.0 | 0.83 |
| | natural | | | | | | | | | |
| 19 (800° C.) | 1010 | | | 4 | 0.3 | 0.1 | 0.0 | 0.4 | 0.0 | 0.84 |
| | | | | nanosize | | | | | | |
| 20 (800° C.) | 1010 | | | | 0.3 | 0.1 | 0.0 | 0.3 | 0.0 | 0.76 |
| | 10 wt % | | | | | | | | | |
| | nanosilica | | | | | | | | | |
| | (Gabot) | | | | | | | | | |
| 21 (800° C.) | 1010 | | | 4 | 0.3 | 0.1 | 0.0 | 0.4 | 0.0 | 0.87 |
| | | | | Merck | | | | | | |
| 22 (800° C.) | 1010 | | | 4 | 0.3 | 0.1 | 0.0 | 0.3 | 0.0 | 0.83 |
| | | | | <5 mm | | | | | | |
| 23 (800° C.) | 1010 | 4 | | | 0.3 | 0.1 | 0.0 | 0.3 | 0.0 | 0.70 |
| 24 (800° C.) | 1010 | | 5 | | 0.3 | 0.1 | 0.0 | 0.2 | 0.0 | 0.70 |
| 25 (800° C.) | 1010 | | | | 0.3 | 0.1 | 0.0 | 0.3 | 0.0 | 0.82 |
| | (natural) | | | | | | | | | |
| 26 (800° C.) | 1010 | | | 7.5 | 0.2 | 0.1 | 0.0 | 0.3 | 0.0 | 0.61 |
| | | | | nanosize | | | | | | |
| 27 (800° C.) | 1010 | | | 10 | 0.2 | 0.2 | 0.0 | 0.3 | 0.0 | 0.68 |
| | | | | nanosize | | | | | | |
| 28 (800° C.) | 1010 | 5 | | 5 | 0.2 | 0.1 | 0.0 | 0.3 | 0.0 | 0.58 |
| | | | | nanosize | | | | | | |
| 29 (800° C.) | 1010 | | 5 | | 0.2 | 0.1 | 0.0 | 0.3 | 0.0 | 0.65 |
| | | | <20 um | | | | | | | |
| 30 (800° C.) | 1010 | | 7.5 | | 0.3 | 0.1 | 0.0 | 0.3 | 0.0 | 0.74 |
| | | | <20 um | | | | | | | |
| 31 (800° C.) | 1010 | | 10 | | 0.2 | 0.1 | 0.0 | 0.3 | 0.0 | 0.74 |
| | | | <20 um | | | | | | | |

TABLE 4
Rₘₐₓ according to BS6853:1999 standard.

| Tested surface | Iₐ | I_{b} | II |
|---|---|---|---|
| Interior horizontal supine surface | 5 | 8 | 18 |
| Interior vertical surfaces | 1 | 1.6 | 3.6 |
| Interior horizontal prone surfaces | 1 | 1.6 | 3.6 |
| Exterior horizontal supine surfaces | 8.5 | 13.5 | nc |
| Exterior vertical surfaces | 1.7 | 2.7 | nc |
| Exterior horizontal prone surfaces | 1.7 | 2.7 | nc |
| Interior minor use materials of 100 gr-500 gr | 1 | 1.6 | 3.6 |
| Exterior minor use materials of 400 gr-2 kg | 1.7 | 2.7 | nc |
| Seat trim | 3.5 | 5.6 | 13 |
| Seat shell | 1 | 1.6 | 3.6 |
| Textiles | 1 | 1.6 | 3.6 |
| Mattresses | 5 | 8 | 8 |
| Interior cables | 1 | 1.6 | 3.6 |
| Exterior cables | 1.7 | 2.7 | nc |

### Example 3

EXAMPLES 32-48 have been prepared according to the methods described above. Tables 5-7 describe the weight percent of each compositional component in the thermoplastic resin.

TABLE 5
Thermoplastic composition used in mechanical, physical and
flammability tests.

| Compositional | EX | EX | EX | EX | EX | EX | EX | EX | EX | EX |
|---|---|---|---|---|---|---|---|---|---|---|
| component | 32 | 33 | 34 | 35 | 36 | 37 | 38 | 39 | 40 | 41 |
| ULTEM 1010 Powder | 100 | 94 | 90 | 94 | 90 | 99 | 98 | 96 | 90 | 90 |
| SiO₂-Momentive | | 6 | 10 | | | | | | | 6 |
| SiO₂_{_{—}}CabOSil TS530 | | | | 6 | 10 | | | | 6 | |
| Cu₂O | | | | | | 1 | 2 | 4 | 4 | 4 |

TABLE 6
Thermoplastic composition used in mechanical, physical and
flammability tests.

| Compositional | EX | EX | EX | EX | EX | EX | EX | EX |
|---|---|---|---|---|---|---|---|---|
| component | 32 | 34 | 36 | 37 | 39 | 41 | 42 | 43 |
| ULTEM 1010 Powder | 100 | 90 | 90 | 99 | 96 | 90 | 94 | 90 |
| SiO₂-Momentive | | 10 | | | | 6 | | |
| SiO₂_{_{—}}CabOSil TS530 | | | 10 | | | | | |
| Cu₂O | | | | 1 | 4 | 4 | | |
| WO₃ | | | | | | | 6 | 10 |

TABLE 7
Thermoplastic composition used in mechanical, physical and
flammability tests.

| Compositional | EX | EX | EX | EX | EX | EX |
|---|---|---|---|---|---|---|
| component | 32 | 44 | 45 | 46 | 47 | 48 |
| ULTEM 1010 Powder | 100 | 97.5 | 95 | 95 | 97.5 | 95 |
| CaO | | 2.5 | 5 | | | |
| Ca(OH)₃ | | | | 5 | | |
| CaCO₃ | | | | | 2.5 | 5 |

### Example 4

EXAMPLES 32-41 have been tested for the mechanical properties. The Notched Izod Impact has been measured according to ISO 527 standard and as described above. Table 8 demonstrates the Notched Izod Impact for EXAMPLES 32-41.

TABLE 8
Notched Izod Impact measured for EXAMPLES 32-41.

| | | | | | Standard |
|---|---|---|---|---|---|
| | | | | Average, | deviation, |
| EXAMPLE | t (mm) | E (J) | kJ/m² | kJ/m² | kJ/m² |
| EX 32 | 7.99 | 0.647 | 20.24 | 12.78 | 7.93 |
| | 8.09 | 0.706 | 21.82 | | |
| | 7.84 | 0.175 | 5.58 | | |
| | 8.02 | 0.161 | 5.02 | | |
| | 7.92 | 0.356 | 11.24 | | |
| EX 33 | 8.03 | 0.399 | 12.42 | 12.45 | 3.40 |
| | 8 | 0.372 | 11.62 | | |
| | 8.03 | 0.385 | 11.99 | | |
| | 7.99 | 0.57 | 17.83 | | |
| | 8.14 | 0.273 | 8.38 | | |
| EX 34 | 8.01 | 0.492 | 15.36 | 13.18 | 3.79 |
| | 7.98 | 0.476 | 14.91 | | |
| | 8.08 | 0.208 | 6.44 | | |
| | 7.9 | 0.452 | 14.30 | | |
| | 7.94 | 0.473 | 14.89 | | |
| EX 35 | 8.1 | 0.623 | 19.23 | 12.52 | 4.42 |
| | 7.97 | 0.403 | 12.64 | | |
| | 7.97 | 0.373 | 11.70 | | |
| | 9.04 | 0.22 | 6.84 | | |
| | 7.78 | 0.38 | 12.21 | | |
| EX 36 | 7.91 | 0.354 | 11.19 | 12.04 | 5.09 |
| | 7.99 | 0.648 | 20.27 | | |
| | 7.86 | 0.198 | 6.29 | | |
| | 8.07 | 0.342 | 10.59 | | |
| | 7.78 | 0.369 | 11.86 | | |
| EX 37 | 8.12 | 0.311 | 9.58 | 8.30 | 1.71 |
| | 7.87 | 0.292 | 9.28 | | |
| | 7.98 | 0.251 | 7.86 | | |
| | 7.96 | 0.175 | 5.50 | | |
| | 7.9 | 0.294 | 9.30 | | |
| EX 38 | 7.84 | 0.229 | 7.30 | 10.71 | 2.80 |
| | 8.2 | 0.372 | 11.34 | | |
| | 7.87 | 0.31 | 9.85 | | |
| | 7.93 | 0.475 | 14.97 | | |
| | 7.92 | 0.320 | 10.10 | | |
| EX 39 | 8.13 | 0.287 | 8.83 | 7.49 | 2.82 |
| | 7.93 | 0.27 | 8.51 | | |
| | 7.93 | 0.143 | 4.51 | | |
| | 8.1 | 0.355 | 10.96 | | |
| | 7.96 | 0.148 | 4.65 | | |
| EX 40 | 7.87 | 0.275 | 8.73 | 7.14 | 2.23 |
| | 7.94 | 0.15 | 4.72 | | |
| | 8.16 | 0.299 | 9.16 | | |
| | 8.04 | 0.151 | 4.69 | | |
| | 7.86 | 0.263 | 8.36 | | |
| EX 41 | 8.05 | 0.325 | 10.09 | 10.37 | 1.77 |
| | 7.82 | 0.264 | 8.44 | | |
| | 7.81 | 0.386 | 12.36 | | |
| | 7.93 | 0.284 | 8.95 | | |
| | 8.19 | 0.394 | 12.03 | | |

### Example 5

Tensile properties of EXAMPLES 32-41 have been measured according to the methods described above and the results are presented in Table 9.

TABLE 9
Tensile testing for EXAMPLES 32-41.

| | E- | | Stress @ | | | | Stress @ | | | |
|---|---|---|---|---|---|---|---|---|---|---|
| | Modulus, | | Yield, | | Strain @ | | Break, | | Strain @ | |
| EX | MPa | SD1 | MPa | SD2 | Yield, % | SD3 | MPa | SD4 | Break, % | SD5 |
| 32 | 3342.69 | 98.71 | 112.34 | 0.55 | 7.68 | 0.11 | 92.18 | 11.70 | 14.77 | 5.76 |
| 33 | 3642.79 | 34.04 | 109.85 | 0.50 | 6.59 | 0.09 | 95.32 | 7.91 | 8.97 | 1.09 |
| 34 | 3789.62 | 47.09 | 108.95 | 0.18 | 6.06 | 0.02 | 97.54 | 6.03 | 8.02 | 0.98 |
| 35 | 3598.68 | 57.74 | 114.95 | 0.24 | 6.94 | 0.07 | 106.71 | 3.51 | 8.40 | 0.54 |
| 36 | 3675.54 | 33.11 | 114.35 | 0.24 | 6.69 | 0.07 | 105.37 | 4.97 | 8.15 | 0.61 |
| 37 | 3378.04 | 19.14 | 113.84 | 0.42 | 7.68 | 0.04 | 84.36 | 1.63 | 17.35 | 6.83 |
| 38 | 3334.02 | 33.77 | 114.44 | 0.24 | 7.70 | 0.04 | 93.30 | 10.59 | 19.08 | 8.49 |
| 39 | 3382.18 | 47.24 | 115.06 | 0.34 | 7.58 | 0.06 | 109.11 | 4.34 | 8.90 | 1.06 |
| 40 | 3658.47 | 60.36 | 114.11 | 0.50 | 6.75 | 0.05 | 100.01 | 9.69 | 8.89 | 1.00 |
| 41 | 3570.85 | 98.63 | 111.17 | 0.13 | 6.44 | 0.04 | 102.24 | 4.09 | 8.10 | 0.67 |

### Example 6

The flammability properties have been measured according to the methods described above. Tables 10-13 show the flammability results measured for the thermoplastic compositions EXAMPLES 32-41.

TABLE 10
Flammability measurements for EXAMPLES 32-41^{a}.

| EXAMPLE | SPECIMEN | TIME T1 | TIME T2 | T1 + T2 | TOTAL |
|---|---|---|---|---|---|
| EX 32 | 1 | 0.5 | 1.2 | 1.7 | 14.1 |
| | 2 | 0.5 | 0.5 | 1 | |
| | 3 | 0.5 | 1.1 | 1.6 | |
| | 4 | 0.5 | 5.3 | 5.8 | |
| | 5 | 0.7 | 3.3 | 4 | |
| EX 32′ | 1 | 0.9 | 1 | 1.9 | 15.6 |
| | 2 | 0.7 | 0.9 | 1.6 | |
| | 3 | 1 | 0.5 | 1.5 | |
| | 4 | 0.9 | 3.7 | 4.6 | |
| | 5 | 0.7 | 5.3 | 6 | |
| EX 33 | 1 | 0.6 | 1.2 | 1.8 | 46.1 |
| | 2 | 0.5 | 6.2 | 6.7 | |
| | 3 | 1.6 | 6.1 | 7.7 | |
| | 4 | 0.6 | 6.1 | 6.7 | |
| | 5 | 0.5 | 27.8 | 28.3 | |
| EX 34 | 1 | 15.1 | 14.9 | 30 | 91.2 |
| | 2 | 13.1 | 1.5 | 14.6 | |
| | 3 | 1.7 | 6.8 | 8.5 | |
| | 4 | 14.7 | 5.2 | 19.9 | |
| | 5 | 17 | 1.2 | 18.2 | |
| EX 35 | 1 | 42.1 | 0.9 | 43 | 134.3 |
| | 2 | 3.3 | 24.4 | 27.7 | |
| | 3 | 2.2 | 4.6 | 6.8 | |
| | 4 | 6.6 | 41.5 | 48.1 | |
| | 5 | 2.6 | 6.1 | 8.7 | |
| EX 36 | 1 | 13.3 | 25.6 | 38.9 | 107.6 |
| | 2 | 10.3 | 12.1 | 22.4 | |
| | 3 | 13.1 | 2.6 | 15.7 | |
| | 4 | 11.5 | 4 | 15.5 | |
| | 5 | 4.7 | 10.4 | 15.1 | |
| EX 37 | 1 | 1.3 | 0.9 | 2.2 | 14.9 |
| | 2 | 0.9 | 5.1 | 6 | |
| | 3 | 0.5 | 0.7 | 1.2 | |
| | 4 | 1.6 | 0.9 | 2.5 | |
| | 5 | 2 | 1 | 3 | |
| EX 37′ | 1 | 0.7 | 2.9 | 3.6 | 9.9 |
| | 2 | 1.2 | 0.3 | 1.5 | |
| | 3 | 0.9 | 0.7 | 1.6 | |
| | 4 | 0.9 | 0.8 | 1.7 | |
| | 5 | 0.7 | 0.8 | 1.5 | |
| EX 38 | 1 | 0.8 | 2.1 | 2.9 | 13.4 |
| | 2 | 0.8 | 0.7 | 1.5 | |
| | 3 | 1.1 | 0.9 | 2 | |
| | 4 | 1 | 0.9 | 1.9 | |
| | 5 | 2.7 | 2.4 | 5.1 | |
| EX 38′ | 1 | 0.8 | 0.6 | 1.4 | 8.2 |
| | 2 | 0.7 | 0.7 | 1.4 | |
| | 3 | 0.6 | 0.5 | 1.3 | |
| | 4 | 0.7 | 0.5 | 1.2 | |
| | 5 | 2.3 | 0.8 | 3.1 | |
| EX 39 | 1 | 0.9 | 0.9 | 1.8 | 6.9 |
| | 2 | 0.7 | 0.9 | 1.6 | |
| | 3 | 0.5 | 0.5 | 1 | |
| | 4 | 0.7 | 0.7 | 1.4 | |
| EX 40 | 1 | 0.6 | 0.5 | 1.1 | 52.6 |
| | 2 | 0.7 | 0.7 | 1.4 | |
| | 3 | 2.2 | 9.1 | 11.3 | |
| | 4 | 0.9 | 8.3 | 9.2 | |
| | 5 | 1 | 6.1 | 7.1 | |
| | 6 | 7.5 | 16.1 | 23.6 | |
| EX 40′ | 1 | 0.7 | 14.4 | 15.1 | 55.1 |
| | 2 | 4.6 | 10 | 14.6 | |
| | 3 | 0.9 | 1.1 | 2 | |
| | 4 | 0.9 | 17.4 | 18.3 | |
| | 5 | 0.8 | 4.3 | 5.1 | |
| EX 41 | 1 | 0.9 | 2.8 | 3.7 | 29.9 |
| | 2 | 1 | 6.6 | 7.6 | |
| | 3 | 0.8 | 3.9 | 4.7 | |
| | 4 | 2.4 | 7.1 | 9.5 | |
| | 5 | 3.7 | 0.7 | 4.4 | |

^{a}Multiple specimens have been tested for each EXAMPLE.

TABLE 11
Flammability measurements for EXAMPLES 32-41.

| | | | Failure Rate | | | Failure Rate |
|---|---|---|---|---|---|---|
| | | | (V0) | | | (V1) |
| | pFTFP | PSA-DPU | 1^{st} submittal | pFTFP | PSA-DPU | 1^{st} submittal |
| Example | (V0) | (V0) | pass | (V1) | (V1) | pass |
| EX 32 | 0.9355 | 8.27E−06 | 1 in 174 | 0.9994 | 6.13E−14 | 1 in 2E+06 |
| EX 33 | 0.1206 | 0.182 | 1 in 1 | 0.6758 | 4.88E−03 | 1 in 7 |
| EX 34 | 4.64E−04 | 0.25 | 1 in 1 | 0.4464 | 0.0372 | 1 in 3 |
| EX 35 | 3.57E−04 | 0.205 | 1 in 1 | 0.205 | 0.133 | 1 in 1 |
| EX 36 | 6.00E−06 | 0.25 | 1 in 1 | 0.6593 | 5.92E−03 | 1 in 7 |
| EX 37 | 0.9834 | 3.66E−08 | 1 in 2612 | 0.99994 | 0.00E+00 | 1 in 1.92E+08 |
| EX 38 | 0.99997 | 0 | 1 in 1E+09 | 1 | 0.00E+00 | undefined |
| EX 39 | 1 | 0 | undefined | 1 | 0.00E+00 | undefined |
| EX 40 | 0.0498 | 0.223 | 1 in 1 | 0.72 | 2.68E−03 | 1 in 10 |
| EX 41 | 0.5711 | 0.0155 | 1 in 4 | 9.83E−01 | 3.98E−08 | 1 in 2506 |

TABLE 12
Flammability measurements for EXAMPLES 32-33, 35, 39, and 41.

| | UL-94 | | Failure Rate | | Failure Rate |
|---|---|---|---|---|---|
| Example | Rating | pFTFP (V0) | (V0) | pFTFP (V1) | (V1) |
| EX 32 | V0 | 0.9355 | 1 in 174 | 0.9994 | 1 in 2E+06 |
| EX 33 | V0* | 0.12055 | 1 in 1 | 0.6758 | 1 in 7 |
| EX 35 | V1 | 3.57E−04 | 1 in 1 | 0.205 | 1 in 1 |
| EX 39 | V0 | 1 | >1 in 1E+08 | 1 | undefined |
| EX 41 | V1 | 0.5711 | 1 in 4 | 0.983 | 1 in 2506 |

TABLE 13
Flammability measurements for EXAMPLES 32-41.

| | | | | Failure Rate | | Failure Rate |
|---|---|---|---|---|---|---|
| | | | | (V0) | | (V1) |
| | | UL-94 | pFTFP | 1^{st} submittal | pFTFP | 1^{st} submittal |
| Example | T1 + T2, s | Rating | (V0) | pass | (V1) | pass |
| EX 32 | 14.1 | V0 | 0.9355 | 1 in 174 | 0.9994 | 1 in 2E+06 |
| EX 33 | 46.1 | V0* | 0.12055 | 1 in 1 | 0.6758 | 1 in 7 |
| EX 34 | 91.2 | V1 | 4.64E−04 | 1 in 1 | 0.4464 | 1 in 3 |
| EX 35 | 134.3 | V1 | 3.57E−04 | 1 in 1 | 0.205 | 1 in 1 |
| EX 36 | 107.6 | V1 | 6.00E−06 | 1 in 1 | 0.6593 | 1 in 7 |
| EX 37 | 14.9 | V0 | 0.9834 | 1 in 2612 | 0.99994 | 1 in 1.92E+08 |
| EX 38 | 13.4 | V0 | 0.99997 | 1 in 1E+09 | 1 | undefined |
| EX 39 | 6.9 | V0 | 1 | undefined | 1 | undefined |
| EX 40 | 55.1 | V1 | 0.0498 | 1 in 1 | 0.72 | 1 in 10 |
| EX 41 | 29.9 | V0 | 0.5711 | 1 in 4 | 9.83E−01 | 1 in 2506 |

### Example 7

Variance in the time glow and flammability ratings according to UL-94 have been measured for the individual EXAMPLES 32, 44-48 and the results are summarized in Tables 14-19.

TABLE 14
Flammability Tests for EXAMPLE 32^{b}.

| Specimen | | | GLOW TIME | | |
|---|---|---|---|---|---|
| EX 32 | TIME T1 | TIME T2 | T3 | T1 + T2 | T2 + T3 |
| 2 | 2 | 2.4 | 0 | 4.4 | 2.4 |
| 3 | 0.9 | 2.4 | 0 | 3.3 | 2.4 |
| 4 | 2.1 | 2.7 | 0 | 4.8 | 2.7 |
| 5 | 1.8 | 2.6 | 0 | 4.4 | 2.6 |
| 6 | 0.6 | 0.7 | 0 | 1.3 | 0.7 |
| | | | Sum | 18.2 | 10.8 |
| | | | Average | 3.64 | 2.16 |
| | | | SD | 1.42 | 0.83 |

^{b}(T1, T2) < 10 s for each specimen, total (T1 + T2) is < 50 s, (T2 + T3) < 30 s for each specimen, Rating: V0.

TABLE 15
Flammability Tests for EXAMPLE 44^{c}.

| Specimen | | | GLOW TIME | | |
|---|---|---|---|---|---|
| EX 44 | TIME T1 | TIME T2 | T3 | T1 + T2 | T2 + T3 |
| 7 | 0.8 | 0.7 | 8 | 1.5 | 8.3 |
| 8 | 1.2 | 1.6 | 12 | 2.8 | 13.6 |
| 9 | 1.7 | 5.2 | 7 | 6.9 | 12.2 |
| 10 | 1 | 1.9 | 14 | 2.9 | 15.9 |
| 11 | 1 | 1.4 | 14 | 2.4 | 15.4 |
| | | | Sum | 16.5 | 65.8 |
| | | | Average | 3.30 | 13.16 |
| | | | SD | 2.09 | 2.90 |

^{c}(T1, T2) < 10 s for each specimen, total (T1 + T2) is < 50 s, (T2 + T3) < 30 s for each specimen, Rating: V0.

TABLE 16
Flammability Tests for EXAMPLE 45^{d}.

| Specimen | | | GLOW TIME | | |
|---|---|---|---|---|---|
| EX 45 | TIME T1 | TIME T2 | T3 | T1 + T2 | T2 + T3 |
| 12 | 0.8 | 0.8 | 21 | 1.6 | 21.8 |
| 13 | 1.8 | 1.3 | 28 | 3.1 | 29.3 |
| 14 | 0.8 | 0.7 | 20 | 1.5 | 20.7 |
| 15 | 2.5 | 1.7 | 20 | 4.2 | 21.7 |
| 16 | 1.5 | 1.1 | 31 | 2.6 | 32.1 |
| | | | Sum | 13 | 125.6 |
| | | | Average | 2.60 | 25.12 |
| | | | SD | 1.12 | 5.21 |

^{d}(T1, T2) < 10 s for each specimen, total (T1 + T2) is < 50 s, (T2 + T3) NOT < 30 s for each specimen, Rating: V1.

TABLE 17
Flammability Tests for EXAMPLE 46^{e}.

| Specimen | | | GLOW TIME | | |
|---|---|---|---|---|---|
| EX 46 | TIME T1 | TIME T2 | T3 | T1 + T2 | T2 + T3 |
| 17 | 1.1 | 1.4 | 36 | 2.5 | 37.4 |
| 18 | 0.9 | 1 | 41 | 1.9 | 42 |
| 19 | 0.9 | 0.7 | 31 | 1.6 | 31.7 |
| 20 | 1.2 | 0.9 | 37 | 2.1 | 37.9 |
| 21 | 1 | 0.8 | 30 | 1.8 | 30.8 |
| | | | Sum | 9.9 | 179.8 |
| | | | Average | 1.98 | 35.96 |
| | | | SD | 0.34 | 4.67 |

^{e}(T1, T2) < 10 s for each specimen, total (T1 + T2) is < 50 s, (T2 + T3) NOT < 30 s for each specimen, Rating: V1.

TABLE 18
Flammability Tests for EXAMPLE 47^{f}.

| Specimen | | | GLOW TIME | | |
|---|---|---|---|---|---|
| EX 47 | TIME T1 | TIME T2 | T3 | T1 + T2 | T2 + T3 |
| 22 | 1.3 | 1.1 | 10 | 2.4 | 11.1 |
| 23 | 1.3 | 2.1 | 7 | 3.4 | 9.1 |
| 24 | 1 | 1.1 | 11 | 2.1 | 12.1 |
| 25 | 0.8 | 0.8 | 11 | 1.6 | 11.8 |
| 26 | 1.2 | 2.2 | 7 | 3.4 | 9.2 |
| | | | Sum | 12.9 | 53.3 |
| | | | Average | 2.58 | 10.66 |
| | | | SD | 0.80 | 1.43 |

^{f}(T1, T2) < 10 s for each specimen, total (T1 + T2) is < 50 s, (T2 + T3) < 30 s for each specimen, Rating: V0.

TABLE 19
Flammability Tests for EXAMPLE 48^{g}.

| Specimen | | | GLOW TIME | | |
|---|---|---|---|---|---|
| EX 48 | TIME T1 | TIME T2 | T3 | T1 + T2 | T2 + T3 |
| 27 | 0.9 | 0.7 | 10 | 1.6 | 10.7 |
| 28 | 1.5 | 2.3 | 7 | 3.8 | 9.3 |
| 29 | 0.7 | 2.3 | 10 | 3 | 12.3 |
| 30 | 1.1 | 0.8 | 9 | 1.9 | 9.8 |
| 31 | 0.9 | 2.9 | 7 | 3.8 | 9.9 |
| | | | Sum | 14.1 | 52 |
| | | | Average | 2.82 | 10.40 |
| | | | SD | 1.04 | 1.17 |

^{g}(T1, T2) < 10 s for each specimen, total (T1 + T2) is < 50 s, (T2 + T3) < 30 s for each specimen, Rating: V0.

### Example 8

Additional thermoplastic resin compositions have been prepared and tensile properties have been measured according to the method described above. The results are summarized in Tables 20-21.

TABLE 20
Tensile properties of the thermoplastic resins.

| | | | | Stress@ | |
|---|---|---|---|---|---|
| | E-Modulus, | Stress@ | Strain@ | Break, | Strain@ |
| EXAMPLE | MPa | Yield, MPa | Yield, % | MPa | Break, % |
| UL-4 | 3143.31 | 111.68 | 8.16 | 85.7 | 54.81 |
| UL-5 | 3160.52 | 111.37 | 8.05 | 99.7 | 10.54 |
| UL-6 | 3213.43 | 111.49 | 8.08 | 84.65 | 59.94 |
| UL-7 | 3196.02 | 111.38 | 8.09 | 101.72 | 10.4 |
| UL-8 | 3302.1 | 34.54 | 1.15 | 83.85 | 22.08 |
| UL-HZSMS-4-1 | 3381.75 | 103.78 | 7.06 | 90.13 | 10.14 |
| UL-HZSMS-4-2 | 3391.47 | 103.79 | 6.92 | 102.93 | 7.36 |
| UL-HZSMS-4-3 | 3528.36 | 103.56 | 7.14 | 81.72 | 9.88 |
| UL-HZSMS-4-4 | 3370.15 | 103.63 | 7.2 | 92.66 | 9.46 |
| UL-HZSMS-4-5 | 3340.41 | 103.73 | 7.03 | 79.99 | 11.46 |
| UL-MgO-4-1 | 3418.88 | 36.94 | 1.14 | 103.95 | 9.96 |
| UL-MgO-4-2 | 3375.33 | 114.01 | 7.74 | 86.32 | 12.62 |
| UL-MgO-4-3 | 3498.87 | 113.14 | 7.69 | 102.85 | 10.17 |
| UL-MgO-4-4 | 3410.48 | | | 17.27 | 0.48 |
| UL-MgO-4-5 | 3551.12 | | | 22.02 | 0.55 |
| UL-MgO-4-6 | 3368.31 | 34.79 | 1.13 | 85.38 | 11.52 |
| UL-ZnO-4-1 | 3338.59 | 36.26 | 1.17 | 86.08 | 38.49 |
| UL-ZnO-4-2 | 3402.52 | 113.4 | 7.92 | 87.6 | 33.38 |
| UL-ZnO-4-3 | 3326.92 | 113.42 | 7.84 | 84.88 | 17.3 |
| UL-ZnO-4-4 | 3304.34 | 113.03 | 7.91 | 112.96 | 8.1 |
| UL-ZnO-4-5 | 3248.2 | 113.05 | 7.95 | 85.67 | 33.68 |
| UL-ZrO₂-4-1 | 3177.22 | 111.97 | 7.99 | 105.41 | 9.7 |
| UL-ZrO₂-4-2 | 33280.3 | 112.23 | 7.95 | 84.67 | 20.48 |
| UL-ZrO₂-4-3 | 3197.87 | 112.27 | 7.98 | 102.95 | 10.29 |
| UL-ZrO₂-4-4 | 3178.01 | 112.33 | 7.9 | 84.51 | 19.17 |
| UL-ZrO₂-4-5 | 3199.36 | 112.16 | 7.94 | 84.8 | 19.68 |
| UL-Fe₂O₃-4-1 | 3331.29 | 35.92 | 1.18 | 84.7 | 11.57 |
| UL-Fe₂O₃-4-2 | 3173.65 | 113.03 | 8.12 | 103.19 | 10.2 |
| UL-Fe₂O₃-4-3 | 3139.1 | 112.92 | 7.93 | 104.85 | 9.69 |
| UL-Fe₂O₃-4-4 | 3234.56 | 112.97 | 7.78 | 104.06 | 10.14 |
| UL-Fe₂O₃-4-5 | 3264.08 | 112.99 | 7.87 | 99.63 | 10.73 |
| UL-CrO₃-4-1 | 3430.78 | | | 9.64 | 0.28 |
| UL-CrO₃-4-1 | 3273.87 | | | 104.54 | 5.76 |
| UL-CrO₃-4-2 | 3410.58 | | | 109.58 | 6.28 |
| UL-CrO₃-4-3 | 3281.8 | | | 104.34 | 5.75 |
| UL-CrO₃-4-4 | 3392.21 | | | 113.56 | 7.81 |
| UL-CrO₃-4-5 | 3359.8 | | | 102.6 | 5.57 |
| UL-Al₂O₃-4-1 | 3533.78 | | | 12.05 | 0.33 |
| UL-Al₂O₃-4-1 | 3514.31 | | | 27.88 | 0.78 |
| UL-Al₂O₃-4-2 | 3525.74 | 111.56 | 7.23 | 106.73 | 8.78 |
| UL-Al₂O₃-4-3 | 3417.27 | 111.21 | 7.39 | 102.77 | 9.35 |
| UL-Al₂O₃-4-4 | 3550.4 | 111.69 | 7.3 | 103.24 | 9.26 |
| UL-Al₂O₃-4-5 | 3512.7 | 111.01 | 7.18 | 106.18 | 8.71 |
| UL-Al₂O₃-4-6 | 3608.91 | 111.25 | 7.17 | 98.58 | 10.02 |
| PP-ASTM-1 | 1660.06 | 18.34 | 1.13 | 20.19 | 24.72 |
| PP-ASTM-2 | 1735.9 | 19.02 | 1.19 | 27.44 | 14.48 |
| PP-ASTM-3 | 1712.22 | 19.07 | 1.21 | 19.61 | 21.11 |
| PP-ASTM4 | 1746.4 | 18.7 | 1.17 | 29.16 | 12.88 |
| PP-20PCT-POPPY-ASTM-1 | 1248.24 | 12.9 | 1.14 | 23.86 | 12.33 |
| PP-20PCT-POPPY-ASTM-2 | 1213.5 | 12.89 | 1.18 | 24.26 | 11.05 |
| PP-20PCT-POPPY-ASTM-3 | 1214.7 | 12.59 | 1.17 | 24.11 | 13.41 |
| PP-20PCT-POPPY-ASTM-3 | 1246.05 | 12.91 | 1.18 | 24.26 | 11.57 |

TABLE 21
Tensile properties of various thermoplastic resins.

| | | | Stress@ | | Stress@ | |
|---|---|---|---|---|---|---|
| | E-Modulus, | | Yield, | Strain@ | Break, | Strain@ |
| EXAMPLE | MPa | SD1 | MPa | Yield, % | MPa | Break, % |
| UL1010 | 3203.1 | 61.9 | 96.1 | 6.7 | 91.1 | 31.6 |
| UL + 4 wt % HZSM5 | 3402.4 | 73.0 | 103.7 | 7.1 | 89.5 | 9.7 |
| UL + 4 wt % MgO | 3437.2 | 72.7 | | | | |
| UL + 4 wt % ZnO | 3324.1 | 55.9 | 97.8 | 6.6 | 91.4 | 26.2 |
| UL + 4 wt % ZrO₂ | 3206.6 | 42.5 | 112.2 | 8.0 | 92.5 | 15.92 |
| UL + 4 wt % Fe₂O₃ | 3228.5 | 75.6 | 97.6 | 6.6 | 99.3 | 10.5 |
| UL + 4 wt % CrO₃ | 3358.2 | 66.5 | | | 90.7 | 5.2 |
| UL + 4 wt % Al₂O₃ | 3521.6 | 62.4 | 111.3 | 7.3 | 103.5 | 9.2 |
| UL_5% CaO | 3425.1 | 56.9 | 102.9 | 7.6 | 94.38 | 9.8 |
| UL_5% CaCO₃ | 3411.3 | 13.9 | 105.5 | 8.0 | 81.2 | 27.5 |
| UL_2.5% CaO | 3364.4 | 42.3 | 103.7 | 8.0 | 94.8 | 10.2 |
| UL_2.5% CaCO₃ | 3384.3 | 40.1 | 105.7 | 7.9 | 80.9 | 23.3 |
| UL_5% Ca(OH)₂ | 3523.8 | 16.5 | | | 94.4 | 5.5 |

### Example 9

Additional thermoplastic resin compositions have been prepared and tested.

TABLE 22
Additives used in the metalloporphyrin and melamine
containing compounds studies.

| Additive | Supplier | Item | Particle size |
|---|---|---|---|
| Kaolin (CAS 1332-58-7) | KAMIN | KaMin HG90 | 0.2-0.4 μm |
| | | (water-washed | |
| | | clay) | |
| Kaolin Clay | KAMIN | Polyfil NG - | 380 nm |
| | | ~380 nm water | |
| | | washed kaolin | |
| | | clay | |
| Calcined Kaolin Clay | KAMIN | Nylok-171- | 1.4 μm |
| | | calcined clay, | |
| | | amino functional | |
| | | surface treatment | |
| 5,10,15,20-Tetrakis(4- | Sigma- | 275867 | |
| methoxyphenyl)- | Aldrich | | |
| 21H,23H-porphine | | | |
| cobalt(II) (CoTPP) | | | |
| CAS 28903-71-1 | | | |
| Melamine polyphosphate | Budenheim | Build 3141 | |
| (MPolyP) | | | |
| CAS 218768-84-4 | | | |

EXAMPLES 42-53 have been prepared according to the methods described above. Table 23 describes the weight percent of each compositional component in the thermoplastic resin.

TABLE 23
Thermoplastic composition used in mechanical, physical and
flammability tests.

| Compo- | | | | | | | | | | | | |
|---|---|---|---|---|---|---|---|---|---|---|---|---|
| sitional | | | | | | | | | | | | |
| com- | EX | EX | EX | EX | EX | EX | EX | EX | EX | EX | EX | EX |
| ponent | 42 | 43 | 44 | 45 | 46 | 47 | 48 | 49 | 50 | 51 | 51 | 53 |
| ULTEM | 100 | 98 | 96 | 90 | 98 | 96 | 90 | 98 | 96 | 90 | 95 | 93.8 |
| 1010 | | | | | | | | | | | | |
| Powder | | | | | | | | | | | | |
| KaMin | | 2 | 4 | 10 | | | | | | | | |
| HG90 | | | | | | | | | | | | |
| Polyfil | | | | | 2 | 4 | 10 | | | | | |
| NG | | | | | | | | | | | | |
| Nylok-171 | | | | | | | | 2 | 4 | 10 | | |
| CoTPP | | | | | | | | | | | 5 | |
| MPolyP | | | | | | | | | | | | 6.2 |

Toxicity tests have been performed by the third party Test Lab—Currenta, according to the BS6853:1999 and EN50305 standards at the chosen temperatures 800° C. The ITC data shown in Table 24 has been measured for various polymer compositions marked as Examples 9-12, 15 and 18-20 and described herein at the temperatures of 800° C. Rₘₐₓ and rₓ data for Examples 42-45, 48 and 51-53, measured at the same temperatures, are shown in Table 25.

TABLE 24
Toxicity data (ITC) measured for
EXAMPLES 9-13, 15 and 18-20.

| | ITC | ITC | ITC | ITC | ITC | ITC | |
|---|---|---|---|---|---|---|---|
| EX | CO | CO₂ | SO₂ | HCN | NOₓ | HF | ITC |
| 42 (800° C.) | 4.0 | 2.0 | 0.0 | 5.5 | 0.0 | 0.0 | 11.4 |
| 43 (800° C.) | 4.1 | 2.0 | 0.0 | 5.5 | 0.0 | 0.0 | 11.6 |
| 44 (800° C.) | 4.2 | 1.9 | 0.0 | 5.5 | 0.0 | 0.0 | 11.6 |
| 45 (800° C.) | 1.7 | 2.7 | 0.0 | 3.9 | 0.0 | 0.0 | 8.4 |
| 46 (800° C.) | 3.1 | 2.0 | 0.0 | 4.2 | 0.0 | 0.0 | 9.3 |
| 51 (800° C.) | 3.9 | 1.9 | 0.0 | 4.5 | 0.0 | 0.0 | 10.3 |
| 52 (800° C.) | 2.5 | 2.3 | 0.0 | 4.9 | 0.0 | 0.0 | 9.6 |
| 53 (800° C.) | 1.9 | 2.3 | 0.0 | 5.1 | 0.2 | 0.0 | 9.6 |

TABLE 25
Toxicity Data: Rₘₐₓ and rₓ values measured
for EXAMPLES 42-45, 48 and 51-53.

| | r | r | r | r | r | |
|---|---|---|---|---|---|---|
| EX | CO | CO₂ | SO₂ | HCN | NOₓ | R |
| 42 (800° C.) | 0.2 | 0.1 | 0.0 | 0.3 | 0.0 | 0.6 |
| 43 (800° C.) | 0.3 | 0.1 | 0.0 | 0.3 | 0.0 | 0.7 |
| 44 (800° C.) | 0.3 | 0.1 | 0.0 | 0.3 | 0.0 | 0.7 |
| 45 (800° C.) | 0.1 | 0.2 | 0.0 | 0.2 | 0.0 | 0.5 |
| 48 (800° C.) | 0.2 | 0.1 | 0.0 | 0.2 | 0.0 | 0.5 |
| 51 (800° C.) | 0.2 | 0.1 | 0.0 | 0.2 | 0.0 | 0.6 |
| 52 (800° C.) | 0.2 | 0.1 | 0.0 | 0.2 | 0.0 | 0.5 |
| 53 (800° C.) | 0.1 | 0.2 | 0.0 | 0.3 | 0.0 | 0.6 |

EXAMPLES 42-51 have been tested for the mechanical properties. The Notched Izod Impact has been measured according to ASTM D 256 standard. Table 26 demonstrates the Notched Izod Impact for EXAMPLES 42-48, 50 and 51.

TABLE 26
Notched Izod Impact measured for EXAMPLES 42-48, 50 and 51.

| | | | Impact Strength, | Impact Strength, |
|---|---|---|---|---|
| | Temperature | | Average, | standard |
| EXAMPLE | (° C.) | E (J) | J/m | deviation, J/m |
| 42 | 23 | 2.76 | 43.0 | 8.38 |
| 43 | 23 | 2.76 | 40.3 | 8.99 |
| 44 | 23 | 2.76 | 47.1 | 2.32 |
| 45 | 23 | 2.76 | 46.3 | 3.43 |
| 46 | 23 | 2.76 | 48.8 | 5.85 |
| 47 | 23 | 2.76 | 43.9 | 8.63 |
| 48 | 23 | 2.76 | 47.5 | 2.48 |
| 50 | 23 | 2.76 | 45.8 | 0.79 |
| 51 | 23 | 2.76 | 52.6 | 3.95 |

Tensile properties of EXAMPLES 42-51 have been measured according to ISO 527 standard and the results are presented in Table 27.

TABLE 27
Tensile testing for EXAMPLES 42-51.

| | | | Strain@ | Stress@ | |
|---|---|---|---|---|---|
| | E-Modulus, | Stress@ | Yield, | Break, | Strain@ |
| EXAMPLE | MPa | Yield, MPa | % | MPa | Break, % |
| 42 | 3118.0 | 106.51 | 6.42 | 80.56 | 29.38 |
| 43 | 3210.0 | 106.83 | 6.2 | 80.41 | 18.0 |
| 44 | 3357.8 | 107.0 | 5.98 | 80.84 | 10.16 |
| 45 | 3756.0 | 102.92 | 4.22 | 102.92 | 4.22 |
| 46 | 3205.8 | 102.16 | 5.08 | 102.58 | 5.28 |
| 47 | 3299.4 | 104.98 | 5.76 | 89.35 | 9.1 |
| 48 | 3726.4 | 102.48 | 4.4 | 102.48 | 4.38 |
| 49 | 3176.0 | 98.12 | 4.53 | 98.12 | 4.56 |
| 50 | 3285.0 | 105.02 | 5.46 | 99.67 | 6.48 |
| 51 | 3606.0 | 105.74 | 4.85 | 105.74 | 4.86 |

The flammability properties have been measured according to the methods described above. Tables 28 show the flammability results measured for the thermoplastic compositions EXAMPLES 42-51.

TABLE 28
Flammability measurements for EXAMPLES 42-51^{a}.

| Example | VX@3 mm | VX@1.5 mm | VX@0.8 mm |
|---|---|---|---|
| 42 | V0 | V0 | V0 |
| 43 | V0 | V0 | V0 |
| 44 | V0 | V0 | V0 |
| 45 | V0 | V0 | V0 |
| 46 | V0 | V0 | V0 |
| 47 | V0 | V0 | V0 |
| 48 | V0 | V0 | V0 |
| 49 | V0 | V0 | V0 |
| 50 | V0 | V0 | V0 |
| 51 | V0 | V0 | V0 |

^{a}Multiple specimens have been tested for each EXAMPLE.

1. A thermoplastic polymer composition comprising:
a) at least one nitrogen containing polymer resin in an amount in the range of from greater than about 0 wt % to about 100 wt %;
b) at least one combustion toxicant suppressant in an amount in the range of from greater than about 0 wt % to about 15 wt %,
wherein the combined weight percent value of all components does not exceed about 100 wt %;
wherein all weight percent values are based on the total weight of the thermoplastic polymer composition;
wherein the thermoplastic polymer composition has a combustion toxicity lower than a combustion toxicity measured for a substantially identical reference composition in the absence of the combustion toxicant suppressant; and
wherein the presence of the combustion toxicant suppressant has no or substantially no impact on the mechanical, physical and flammability properties.

2. The thermoplastic polymer composition of claim 1, wherein the nitrogen containing polymer resin comprises polyamides, polyimides, polyurethanes, or any combination or blend thereof.

3. The thermoplastic polymer composition of claim 1, wherein the nitrogen containing resin comprises a polyetherimide resin.

4. The thermoplastic polymer composition of claim 3, wherein the polyetherimide resin comprises a polyetherimide homopolymer, a copolymer, or any combination or blend thereof.

5. The thermoplastic polymer composition of claim 3, wherein the polyetherimide has a structure of: 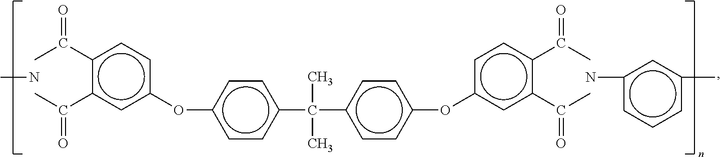
wherein n is an integer greater than 1, and wherein the polyetherimide has a molecular weight of at least 20,000 Daltons.

6. The thermoplastic polymer composition of claim 1, wherein the combustion toxicant suppressant comprises a metal oxide, a metalloporphyrin compound, a melamine compound or a combination thereof.

7. The thermoplastic polymer composition of claim 6, wherein the combustion toxicant suppressant comprises the metal oxide, and wherein the metal oxide comprises an oxide of transition metals, alkaline earth metals, metallic elements of Groups 3A, 4A, and 5A of the periodic table of elements, or any combination thereof.

8. The thermoplastic polymer composition of claim 6, wherein the combustion toxicant suppressant comprises a metal oxide, and wherein the metal oxide comprises an oxide of copper, tungsten, zinc oxide, or any combination thereof.

9. The thermoplastic polymer composition of claim 8, wherein the metal oxide comprises an oxide of Cu(I), Cu(II), or a combination thereof.

10. The thermoplastic polymer composition of claim 8, wherein the metal oxide comprises an oxide of tungsten (VI).

11. The thermoplastic polymer composition of claim 6, wherein the melamine compound is represented by formula: 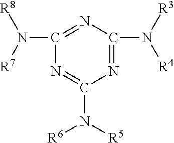
wherein R³-R⁸ are independently selected from hydrogen, monovalent hydrocarbon radicals, substituted monovalent hydrocarbon radicals, —CH₂OH, or —CH₂O(CH₂)ₓH, wherein x is an integer of from 1 to about 4, with the proviso that when R³-R⁸ are selected from monovalent hydrocarbon radicals or substituted monovalent hydrocarbon radicals, the total number of carbon atoms present in R³-R⁸ does not exceed 20.

12. The thermoplastic polymer composition of claim 1, wherein the thermoplastic polymer composition passes the BS6853:1999 test of the British Rail-standard when tested at a temperature about 600° C.

13. The thermoplastic polymer composition of claim 1, wherein a toxicity index value is less than 15 when measured at temperatures in the range of from 500° C. to 900° C.

14. The thermoplastic polymer composition of claim 1, further comprising an inorganic filler, wherein the inorganic filler comprises a kaolin, carbon fiber, carbon black, glass fiber, aramid fiber, or a combination thereof.

15. The thermoplastic polymer composition of claim 1, wherein the composition can further comprise at least one flame retardant.

16. A method of forming the thermoplastic polymer composition of claim 1 comprising: combining the nitrogen containing polymer resin and the combustion toxicant suppressant.

17. The method of claim 16, further comprising extruding the thermoplastic polymer composition.

18. An article formed from the thermoplastic polymer composition of claim 1.

19. The article of claim 18 comprising textiles, mattresses, seats, exterior and interior materials used in a transportation industry.

20. (canceled)
